(19) United States
(12) Patent Application Publication
(10) Pub. No.: US 2010/0061611 A1
(43) Pub. Date: Mar. 11, 2010

(54) CO-REGISTRATION OF CORONARY ARTERY COMPUTED TOMOGRAPHY AND FLUOROSCOPIC SEQUENCE

(75) Inventors: Chenyang Xu, Berkeley, CA (US); Hari Sundar, Piscataway, NJ (US); Luc Duong, Montreal (CA); Rui Liao, Princeton Junction, NJ (US); Andreas Meyer, Bubenreuth (DE); Ulrich Bill, Effeltrich (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Corporate Research, Inc., Princeton, NJ (US)

(21) Appl. No.: 12/545,922

(22) Filed: Aug. 24, 2009

Related U.S. Application Data
(60) Provisional application No. 61/096,055, filed on Sep. 11, 2008.

(51) Int. Cl. G06K 9/00; G06T 15/00; G01N 23/00

(52) U.S. Cl. 382/131; 345/419; 378/4

(57) ABSTRACT

A method for displaying real-time imagery of coronary arteries including a chronic total occlusion (CTO) includes acquiring three-dimensional image data of coronary arteries using a three-dimensional medical imaging device, wherein the three-dimensional image data includes imagery of the CTO. A radiocontrast agent is administered to a patient. Real-time image data of the coronary arteries are acquired using one or more fluoroscopes. The real-time image data does not include imagery of the CTO and down-stream vessel structure. The three-dimensional image data is co-registered with the real-time image data using an image processing device within a vicinity of the CTO. The co-registered image data are displayed in real-time using a display device to accurately illustrate the location of the CTO within the context of the real-time image data.

### CROSS-REFERENCE TO RELATED APPLICATION

The present application is based on provisional application Ser. No. 61/096,055, filed Sep. 11, 2008, the entire contents of which are herein incorporated by reference.

### BACKGROUND OF THE INVENTION

1. Technical Field

The present disclosure relates to imaging of the coronary artery and, more specifically, to co-registration of coronary artery computed tomography and fluoroscopic sequence.

2. Discussion of Related Art

Coronary arteries are the blood vessels that supply the myocardium with oxygenated blood. Atherosclerosis is the condition in which an artery wall thickens as the result of a build-up of fatty materials such as cholesterol. Advanced atherosclerosis may occlude the passage of blood through the arteries potentially leading to stenosis of the artery and/or aneurysm. Occlusion of the arteries may be particularly life-threatening when it occurs in the coronary arteries as myocardial infarction may occur.

Advanced atherosclerosis of the coronary arteries may be called chronic total occlusion (CTO). FIG. 4 shows an illustration of a CTO wherein a vessel 40 is fully blocked by an occlusion 42, this illustration is not meant to be indicative of what may be seen by a fluoroscope. Treatment for CTO of the coronary arteries may involve percutaneous coronary intervention (PCI) such as angioplasty where a catheter is inserted into the occluded artery with the intention of widening the artery.

Traditionally, PCI is performed with the guidance of a fluoroscope, which is a two-dimensional x-ray imager that is capable of producing a real-time image sequence. Radiocontrast is typically administered into the blood stream of the patient prior to fluoroscopy so that the blood vessels may be clearly seen as the radiocontrast flows therethrough. The physician performing the intervention may then insert a guide wire through the blood vessels while relying on the real-time fluoroscope imagery for guidance. However, in the case of CTO, the fact that little to no blood actually flows through the vessel means that insufficient radiocontrast is carried through the vessel and thus the occluded vessel may not be visible within the fluoroscope sequence. In FIG. 4, the occlusion 42 prevents the flow of blood and thereby radiocontrast though the vessel 40. For this reason, it may be difficult to guide the guidewire 41 through the vessel 40 at the point of occlusion 42 due to lack of adequate visualization. Percutaneous coronary intervention is therefore difficult to perform on a vessel subject to CTO using conventional imaging techniques.

### SUMMARY

A method for displaying real-time imagery of coronary arteries including a chronic total occlusion (CTO) includes acquiring three-dimensional image data of coronary arteries using a three-dimensional medical imaging device, wherein the three-dimensional image data includes imagery of the CTO. A radiocontrast agent is administered to a patient. Real-time image data of the coronary arteries are acquired using one or more fluoroscopes. The real-time image data does not include imagery of the CTO and down-stream vessel structure. The three-dimensional image data is co-registered with the real-time image data using an image processing device within a vicinity of the CTO. The co-registered image data are displayed in real-time using a display device to accurately illustrate the location of the CTO within the context of the real-time image data.

Co-registering the three-dimensional image data with the real-time image data may include segmenting the three-dimensional image data. A vessel structure may be identified within the segmented image data by detecting a centerline path. An optimal articulation of the one or more fluoroscopes may be determined and each of the one or more fluoroscopes may be set to the respective optimal articulation while real-time image data is acquired. An initial co-registration of coronary arteries may be performed using the identified vessel structure within the three-dimensional image data and the real-time image data. A registration matrix may be automatically estimated for the three-dimensional image data and the real-time image data based on the initial co-registration. Hybrid visualization may be automatically rendered by combining the three-dimensional image data and the real-time image data according to the estimated registration matrix.

The three-dimensional image data of the coronary arteries may be multi-slice computed tomography (MSCT) image data and the three-dimensional medical imaging device is a computed tomography (CT) scanner. More generally, the three-dimensional medical imaging device may be any three-dimensional modality with the ability to visualize the vasculature. Examples of such a modality may include a three-dimensional MR such as time of flight (TOF) or X-ray Dyna-CT. The one or more fluoroscopes may acquire two-dimensional image data in real-time.

The displayed co-registered image data may be used for guidance in performing percutaneous coronary intervention (PCI) for coronary arteries.

The three-dimensional image data may include motion characteristics for the coronary arteries across a cardiac cycle.

Electrocardiography (ECG) data may be acquired along with the three-dimensional image data so that the displaying of the co-registered image data in real-time may be gated such that the co-registered image data is only displayed when the stage of the cardiac cycle of the real-time image data matches the stage of cardiac cycle in which the three-dimensional image data was acquired.

The three-dimensional image data may include motion characteristics for the coronary arteries across a cardiac cycle and wherein electrocardiography (ECG) data is acquired along with the three-dimensional image data so that the co-registered image data may be displayed in real-time such that the stage of the cardiac cycle of the real-time image data matches the stage of cardiac cycle of the three-dimensional image data.

The three-dimensional image data may be acquired while the patient is holding breath and breathing motion of the real-time image data is compensated for prior to co-registration.

The one or more fluoroscopes may include a first fluoroscope at a first angulation and a second fluoroscope at a second angulation, wherein the difference between the first and second angulation is between 30 and 90 degrees.

Within the display of the co-registered image data in real-time, arterial plaque image data from the three-dimensional image data may be overlaid upon receiving a user-instruction.

A system for displaying real-time imagery of coronary arteries includes a first medical imaging device for acquiring three-dimensional image data of coronary arteries. A second medical imaging device acquires real-time image data of the coronary arteries. An image processing device co-registers the acquired three-dimensional image data with the real-time image data and distorting the three-dimensional image data in real-time to continuously align with the real-time image data. A display device displays the real-time image data superimposed with the continuously aligned three-dimensional image data.

The first medical imaging device may be computed tomography (CT) scanner and the three-dimensional image data may be multi-slice computed tomography (MSCT). The second medical imaging device may be a fluoroscope.

The image processing device may execute a co-registration routine to perform method steps including segmenting the three-dimensional image data; identifying a vessel structure within the segmented image data by detecting a centerline path; determining an optimal articulation of the one or more fluoroscopes and setting each of the one or more fluoroscopes to the respective optimal articulation while real-time image data is acquired; performing an initial co-registration of coronary arteries using the identified vessel structure within the three-dimensional image data and the real-time image data; automatically estimating a registration matrix for distorting the three-dimensional image data to continuously align with the real-time image data based on the initial co-registration; and rendering a superimposed visualization by combining the three-dimensional image data and the real-time image data according to the estimated registration matrix.

A computer system includes a processor and a program storage device readable by the computer system, embodying a program of instructions executable by the processor to perform method steps for displaying real-time imagery of coronary arteries. The method includes acquiring three-dimensional image data of coronary arteries using a three-dimensional medical imaging device. Real-time image data of the coronary arteries is acquired using one or more fluoroscopes. The three-dimensional image data is co-registered with the real-time image data using an image processing device. The co-registered image data is displayed in real-time using a display device. Co-registering the three-dimensional image data with the real-time image data includes segmenting the three-dimensional image data; identifying a vessel structure within the segmented image data by detecting a centerline path; determining an optimal articulation of the one or more fluoroscopes and setting each of the one or more fluoroscopes to the respective optimal articulation while real-time image data is acquired; performing an initial co-registration of coronary arteries using the identified vessel structure within the three-dimensional image data and the real-time image data; automatically estimating a registration matrix for the three-dimensional image data and the real-time image data based on the initial co-registration; and rendering a hybrid visualization by combining the three-dimensional image data and the real-time image data according to the estimated registration matrix.

The displayed co-registered image data may be used for guidance in performing percutaneous coronary intervention (PCI) for coronary arteries.

Electrocardiography (ECG) data may be acquired along with the three-dimensional image data so that the displaying of the co-registered image data in real-time may be gated such that the co-registered image data is only displayed when the stage of the cardiac cycle of the real-time image data matches the stage of cardiac cycle in which the three-dimensional image data was acquired.

The three-dimensional image data includes motion characteristics for the coronary arteries across a cardiac cycle and wherein electrocardiography (ECG) data is acquired along with the three-dimensional image data so that the co-registered image data is displayed in real-time such that the stage of the cardiac cycle of the real-time image data matches the stage of cardiac cycle of the three-dimensional image data.

The one or more fluoroscopes may include a first fluoroscope at a first angulation and a second fluoroscope at a second angulation. The difference between the first and second angulation may be between 30 and 90 degrees.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flow chart illustrating an approach for displaying co-registered guidance imagery according to an exemplary embodiment of the present invention;

FIG. 2 illustrates exemplary MSCT image slices and/or vies showing occluded coronary arteries;

FIG. 3 is a flow chart illustrating a detailed approach for co-registration of the fluoroscope image sequence and the planning imagery according to an exemplary embodiment of the present invention;

FIG. 4 is an illustration of a CTO wherein a vessel is fully blocked by an occlusion; and

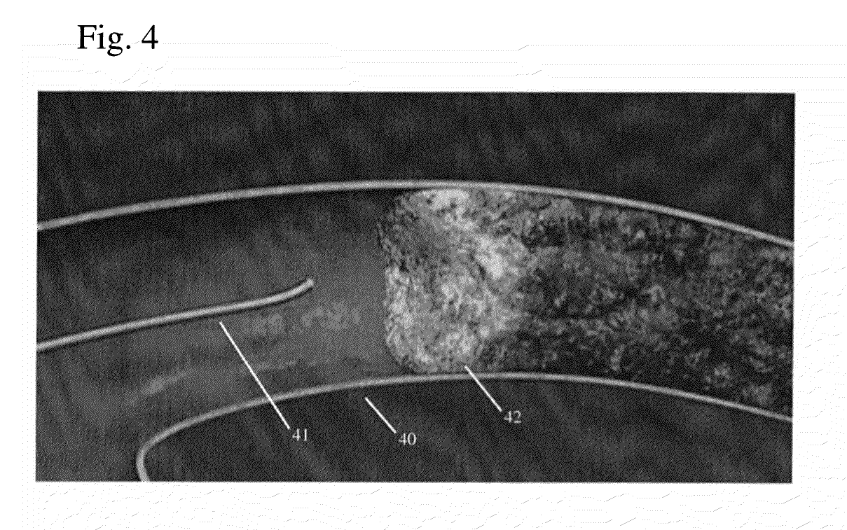

FIG. 5 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific ten sinology so selected, and it is to be understood that each specific element includes all technical equivalents which operate in a similar manner.

Exemplary embodiments of the present invention seek to provide an approach for the imaging of coronary arteries that may be suitable for the performance of percutaneous coronary intervention (PCI) for coronary arteries with chronic total occlusion (CTO). This imaging may be performed using a novel approach for co-registering three-dimensional computed tomography (CT) imagery with real-time fluoroscope imagery and displaying the co-registered image data during the performance of PCI.

As discussed above, fluoroscopic imagery may provide a sequence of two-dimensional x-ray images that may be displayed substantially in real-time and this display may be used as a guide for performing PCI. However, as arteries with CTO may not be sufficiently visible within the fluoroscopic sequence, enhanced imagery may be provided by superimposing the fluoroscopic imagery with co-registered CT imagery so that fine details of the CT imagery, including the occluded vessels, may be incorporated into the real-time display of guidance imagery.

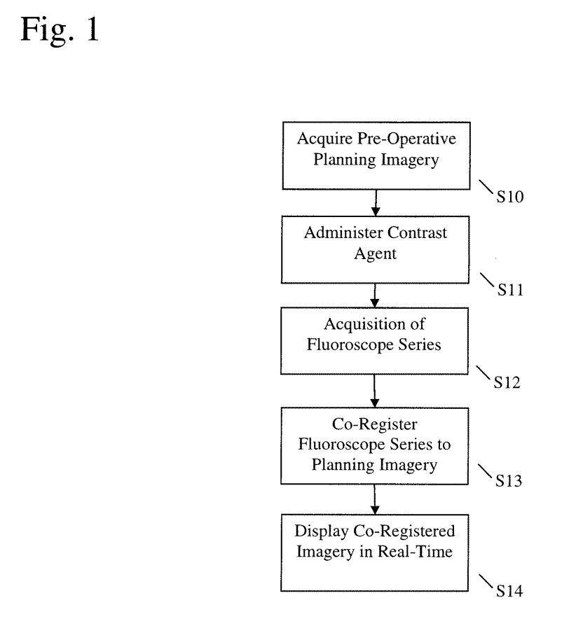

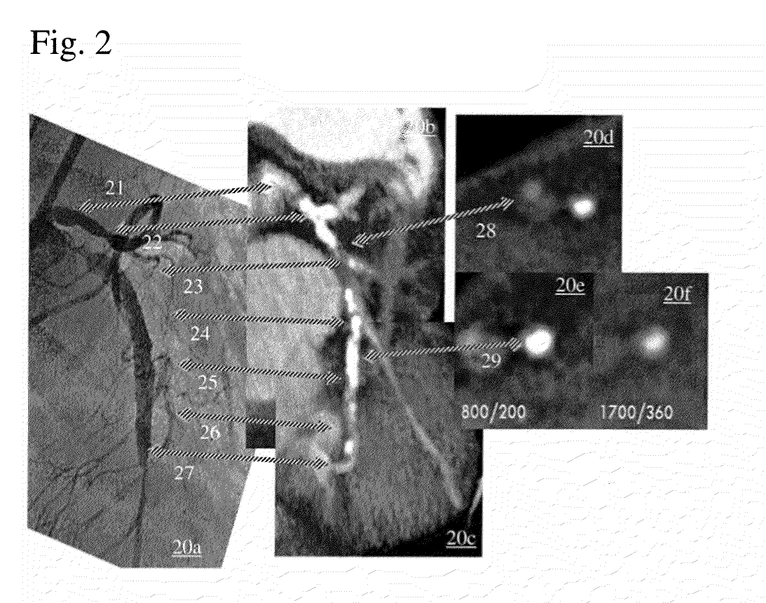

FIG. 1 is a flow chart illustrating an approach for displaying co-registered guidance imagery according to an exemplary embodiment of the present invention. First, pre-operative planning imagery may be acquired (Step S10). The planning imagery may be three-dimensional CT image data, for example, multi-slice computed tomography (MSCT) image data. MSCT is an example of an advanced CT modality that can capture fine structural details of the subject anatomy. For example, using this modality, individual vessels may be clearly imaged and plaque lining the vessels may be identified, as can be seen, for example, in FIG. 2 which illustrates exemplary MSCT image slices and/or views showing occluded coronary arteries. In this figure, exemplary coronary artery occlusions 21-29 may be seen in one or more of five MSCT slices and/or views 20a, 20b, 20c, 20d, 20e, and 20f. Where the same occlusion is seen in multiple slices and/or views, theses instances are illustrated by the use of arrows.

The planning imagery may be four-dimensional MSCT image data. Four-dimensional MSCT image data may capture imagery showing the three spatial dimensions as well as changes with respect to time. In this way, four-dimensional MSCT image data captures motion characteristics of the heart and coronary arteries, and in particular, motion of the cardiac cycle. Electrocardiography (ECG) data may be recorded along with the four-dimensional MSCT image data so that the progression of motion may be indexed to the stages of the cardiac cycle so that the full range of motion of the heart and coronary arteries may be understood.

The planning imagery may be acquired while the patient is holding breath to eliminate the effects of breathing motion.

The planning imagery may also or alternatively include magnetic resonance imagery (MRI) data that may be co-registered to the fluoroscope image sequence.

After the planning image data is acquired, radiocontrast may be administered into the patient's bloodstream (Step S11). The fluoroscope image sequence may then be acquired (Step S12). The fluoroscopic imagery may be a short monoplane sequence. Acquisition of the fluoroscope image sequence may be performed, for example, using one or more fluoroscopes, each mounted on a c-arm. Where multiple fluoroscopes are used, for example, to achieve higher accuracy and/or to further constrain co-registration, each may be positioned at a unique angle. The angle between the two fluoroscopic sequences may be between 30 degrees and 90 degrees. The fluoroscope image sequence(s) may be two-dimensional

An ECG signal may be recorded as the fluoroscopic sequence is acquired. For this recording, cardiac phase for frames in the fluoroscopic sequence may be determined by automatically detecting the peak of the QRS complex. A single frame of the fluoroscopic sequence that matches the cardiac phase in which the MSCT volume was acquired in may then be automatically selected for subsequent co-registration by considering the percentage of the R-R interval (the time duration between two consecutive R waves of the ECG) that the single frame represents and the maximum presence of contrast agent at that point. Since cardiac motion is interleaved with the cycle of breathing motion, the ECG-gated frames may contain only breathing motion, with small and typically negligible deformations. Rigid-body transformation may therefore be sufficient for registration between the MSCT volume and ECG-gated fluoroscopy images.

Where a second fluoroscopic sequence is utilized to provide a more robust registration, c-arm angulation may be used to further constrain the co-registration. The angle between the two fluoroscopic sequences may be at least 30 degrees and may be, for example, 90 degrees or just under 90 degrees. ECG-gating may then be applied to the second fluoroscopic sequence in the same manner as that for the first fluoroscopic sequence.

When using two fluoroscopic sequences, correspondent images from the same breathing phase may be selected for registration. Exemplary embodiments of the present invention may accomplish this goal by performing respiratory gating visually, a process that may be called visual breathing gating. Here, a landmark (e.g. a vessel bifurcation) may be picked on the selected ECG-gated frame from the first fluoroscopic sequence and the corresponding epipolar line may be identified on the second fluoroscopic sequence. All the ECG-gated frames from the second fluoroscopic sequence may then be identified and the frame whose corresponding landmark coincides best with the epipolar line is selected for the subsequent registration.

As the fluoroscope image sequence is acquired, the fluoroscope image sequence may be co-registered to the planning imagery (Step S13) such that both sets of image data may be mapped onto a common space. The co-registered fluoroscope image sequence and the planning imagery may then be displayed in real-time to provide visual guidance for interventional procedures (Step S14).

Of the above-mentioned steps, co-registration of the fluoroscope image sequence and the planning imagery (Step S13) is of particular note and exemplary embodiments of the present invention seek to provide a novel workflow for performing this step. This co-registration is particularly difficult owing to both the cardiac cycle and breathing motion and the fact that during these motions, the boundaries of and spatial relationship between various anatomical structures tends to distort. Exemplary embodiments of the present invention utilize a novel user-guided automated registration technique for co-registration that is capable of effectively overlaying MSCT coronary planning imagery and plaque information onto fluoroscopic sequences for image-guided CTO planning and navigation. This approach to registration may utilize a reliable registration scheme at the setup of the intervention, an efficient way of updating the registration during the intervention if the patient moves, dynamic compensation for breathing motion, as well as integrated visualization tools for augmented MSTC-fluoroscopy image fusion.

This new registration technique may be automated to a great extend and hence there may be a high degree of reproducibility while the total time and interaction for achieving the registration is minimized.

However, before applying fully automatic co-registration, the orientation of the MSCT volume may be roughly aligned with respect to the fluoroscopic imaging system based on pre-operative three-dimensional imaging acquisition parameters, such as, for example, projective information stored in the DICOM header, and the current c-arm orientation and acquisition parameters. In addition, a translation of the MSCT volume may be calculated using one or more identified landmarks. For example, a user may select two corresponding landmarks on the two fluoroscopic images and by assembling the location information concerning a single point as observed from two distinct fluoroscope views, a pseudo three-dimensional point may be reconstructed and then translated to be coincident with the corresponding three-dimensional landmark picked on the MSCT volume. In this way, two or more fluoroscope views may be accurately registered to the three-dimensional space of the MSCT image volume.

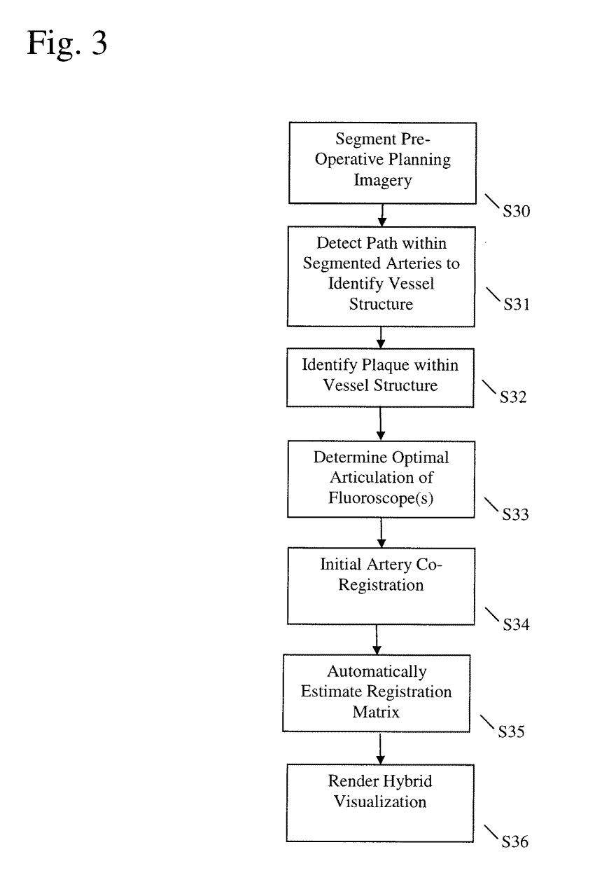

FIG. 3 is a flow chart illustrating a detailed approach for co-registration of the fluoroscope image sequence and the planning imagery according to an exemplary embodiment of the present invention. First, the planning imagery, which may be, for example, MSCT image data, may be segmented (Step S30). Segmentation may include locating and defining the perimeter of the left anterior descending artery (LAD), the left circumflex artery (LCx), and the right coronary artery (RCA) from the MSCT volume. Segmentation may include establishing one or more seed points, either automatically or manually on the ostia of the right and left coronary arteries. A probabilistic front propagation may be used to produce an approximate segmentation of the vessel from the seeds. Next, a path, for example, a centerline, may be detected within the segmented arteries to generate a vessel structure connecting the seed points (Step S31).

Exemplary embodiments of the present invention may perform co-registration between MSCT and fluoroscopy by registering the centerlines of the coronary artery segmentation from MSCT and the centerlines of the two-dimensional coronary arteries shown in fluoroscopy. Identification of the targeted vessel from the 2D fluoroscopic images may be performed fully automatically by use of vessel segmentation or may rely on a simple, yet user friendly input method by which the user identifies at least one seed point at each of the proximal and distal part of a vessel branch. Computational efficiency may be achieved by the use of a distance transform that may be computed from the two-dimensional centerlines of coronary arteries. The distance transform mat then be used to register the MSCT volume to fluoroscopic image, for example, using an Iterative Closest Point (ICP) approach.

Once the path has been determined, an accurate cross sectional geometric model may be created. A geometric mesh and a segmentation mask may both be generated from the cross-sections. Plaques may then be identified by applying a threshold on the MSCT intensities from the segmentation mask (Step S32).

As indicated above, the fluoroscope image sequence data may be acquired using one or more fluoroscopes, each mounted on a c-arm. Optimal angulations of the one or more fluoroscope c-arms may be determined based on the results of the segmentation (Step S33). By planning the optimal angles views using the segmentation, the amount of radiation exposure and the amount of contrast agent used can be reduced significantly. The fluoroscopes may then be adjusted to the determined optimal angles.

An initial coronary artery co-registration of fluoroscopy with MSCT may be performed (Step S34). The co-registration procedure may match the fluoroscope image sequence with the MSCT image data by identifying the ECG phase of the MSCT data and then selecting a frame from the fluoroscope sequence that has the same ECG phase. A rough alignment may then be performed, for example, using DICOM information from the MSCT and C-arm geometry from typically one or two fluoroscopic sequences. When two fluoroscopic sequences are used to achieve higher accuracy, proper breathing compensation may be used to provide for valid reconstructed 3D landmark points and a valid registration result.

After initial registration, breathing motion compensation may be achieved by tracking the guidewire throughout the execution of the intervention procedure and the registration may be updated locally to follow a motion estimated from guidewire tracking by applying co-registration between the MSCT coronary centerline and tracked guidewire result.

Exemplary embodiments of the present invention may also be able to compensate for slight patient movement during the intervention procedure. Here, manual local adjustment of MSCT volume may allow for the user to modify the registration using input, for example, mouse manipulation to reflect patient movement. Large patient motion may be handled by implementing a fully automatic re-registration based on the same workflow described herein. Re-registration may be performed when large patient motion is detected and may begin at any time point or step.

After the initial co-registration, an automated registration procedure may then be employed to automatically estimate the registration matrix between the 3D pre-operative data space and the fluoroscopic space (Step S35). The registration matrix may represent the spatial relationship between the fluoroscopic sequence and the MSCT and may thus allow for the simultaneous and specially co-registered display.

If the image quality is poor and/or the breathing motion is large, exemplary embodiments of the present invention may allow a user to perform an optional initial registration, for example, a landmark-based registration and/or an interactive registration to better constrain the automated registration. An example of an interactive registration technique that may be used here is described in detail below.

After the automated registration has been performed, hybrid visual data may be rendered by combining the co-registered fluoroscope imagery along with the MSCT (Step S36). Here, detection and tracking techniques may be used to track a guidewire or a coronary vessel that is not subject to CTO and thus is visible with contrast, and a real-time registration may be used to update the co-registration to follow the motion caused by such factors as breathing on ECG-gated fluoroscopic images, misalignment by patient motion or adaptation to new fluoroscopic viewing angles.

The result of the co-registration may be used to allow the MSCT volume to be overlaid with the fluoroscopy for planning and navigation during the procedure. During display, various overlays such as a three-dimensional coronary centerline, a mesh, a cross section and a plaque mask may be toggled on and off independently, for example, in accordance with user-provided commands. The blending weight used to fuse the overlays may also be adjusted by the user for optimal guidance.

Various changes may be made to the above-described workflow without deviating from the central ideas expressed herein. For example, the guide wires shown in the fluoroscope imagery may also be used to drive the initial registration using the location constraint-based co-registration if the guide wire is inserted into the vessel branch that is segmented from MSCT volume.

Automated local registration of one or more selected coronary branches may be performed using exemplary embodiments of the present invention by designing the user interface to permit the selection of coronary branches to be used for registration.

When two fluoroscopic images corresponding to the same cardiac and respiratory phases are available, either produced by biplane system or selected by the cardiac and respiratory gating method articulated above, three-dimensional reconstruction of the coronary arteries from the two fluoroscopic images may be achieved and registration can then be performed by 3D-to-3D registration between the reconstructed coronary artery and the segmentation from MSCT.

Registration between coronary artery tree from within the MSCT and the fluoroscopy may be non-ridged, which may account for non-rigid local deformation from breathing and in particular from cardiac motion when navigation and guidance for all cardiac phases is desired. Non-rigid registration may be performed by direct non-rigid deformation on the three-dimensional coronary centerlines. Alternatively, non-rigid registration may be performed by first performing global rigid registration of the three-dimensional coronary centerlines and then deforming two-dimensional projections of the centerlines in an imaging plane.

When four-dimensional MSCT data, including change over time, is available, the current approach may be extended to perform rigid registration between the four-dimensional MSCT data and the fluoroscopic images and accordingly, dynamic CT guidance at all cardiac phases may be three-dimensional MSCT, as described above. The registration between the image series of the moving fluoroscope and the image series of the time-dependent four-dimensional MSCT data may be performed frame by frame, wherein the frames are first matched up according to cardiac cycle. Where the cardiac cycle recorded in each instance has a unique period, frame interpolation may be used to produce frame-by-frame matches between the two data sources. Here, the pre-operative four-dimensional dataset may be treated as a sampling of the possible shapes or configurations that the heart achieves during the cardiac cycle. The approach to co-registration used here is otherwise similar to the approach discussed in detail above; however, in this case we add an extra parameter for the cardiac phase. This parameter may be initialized using the current ECG phase and then optimized along with other parameters to achieve optimal shape matching. Variation due to breathing need not be addressed by this model since the four-dimensional MSCT dataset may be acquired under breath-hold. However, as described above, breathing may be compensated for in the fluoroscope series using the guide wire tracking.

It should also be understood that where exemplary embodiments of the present invention are adapted for situations in which it is difficult for the patient to hold breath during the four-dimensional MSCT acquisition, breathing may also be compensated for within this dataset without going beyond the scope of the instant invention.

Accordingly, exemplary embodiments of the present invention may provide for an efficient and reliable 2D-3D registration method to co-register MSCT data with fluoroscopic images using contrast-enhanced coronary arteries and/or devices used routinely during the CTO intervention. This registration method may be preformed either fully automatically or with user supplied initialization constraints.

Co-registration according to exemplary embodiments of the present invention may be able to handle both cardiac-gating and respiratory-gating to provide 2D-to-3D registration of coronary arteries using two views acquired non-simultaneously on monoplane system or simultaneously on bi-plane system. Alternatively, co-registration may be able to provide 3D-to-3D registration of coronary arteries when fluoroscopic imagery is combined from multiple angles to provide a calculated three-dimensional fluoroscope sequence.

Exemplary embodiments of the present invention may utilize devices that are routinely used during CTO procedures for breathing motion compensation, without requiring additional markers such as the guide wire to be implanted into patients.

Exemplary embodiments of the present invention may also provide image-based planning and navigation for CTO-related intervention procedures by utilizing preoperative MSCT data for constructing a three-dimensional roadmap and integrated visualization of fused MSCT and fluoroscopic images.

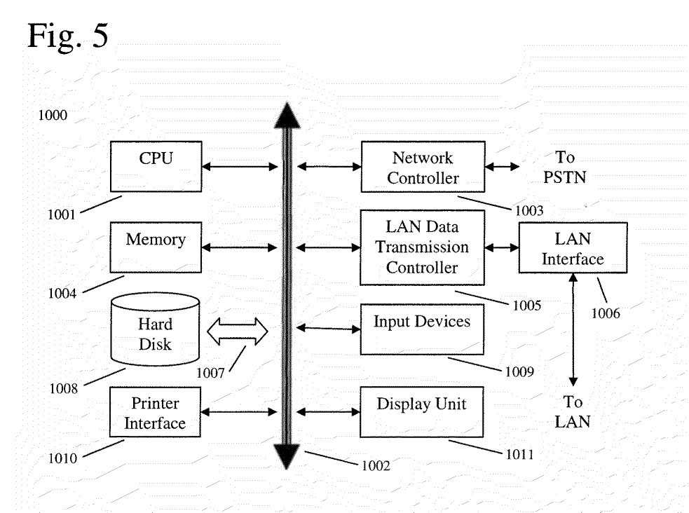

FIG. 5 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for displaying real-time imagery of coronary arteries including a chronic total occlusion (CTO), comprising:
acquiring three-dimensional image data of coronary arteries using a three-dimensional medical imaging device, wherein the three-dimensional image data includes imagery of the CTO;
administering a radiocontrast agent to a patient;
acquiring real-time image data of the coronary arteries using one or more fluoroscopes, wherein the real-time image data does not include imagery of the CTO and down-stream vessel structure;
co-registering the three-dimensional image data with the real-time image data using an image processing device within a vicinity of the CTO; and
displaying the co-registered image data in real-time using a display device to accurately illustrate the location of the CTO within the context of the real-time image data.

2. The method of claim 1, wherein co-registering the three-dimensional image data with the real-time image data includes:
segmenting the three-dimensional image data;
identifying a vessel structure within the segmented image data by detecting a centerline path;
determining an optimal articulation of the one or more fluoroscopes and setting each of the one or more fluoroscopes to the respective optimal articulation while real-time image data is acquired;
performing an initial co-registration of coronary arteries using the identified vessel structure within the three-dimensional image data and the real-time image data;
automatically estimating a registration matrix for the three-dimensional image data and the real-time image data based on the initial co-registration; and
rendering a hybrid visualization by combining the three-dimensional image data and the real-time image data according to the estimated registration matrix.

3. The method of claim 1, wherein the three-dimensional image data of the coronary arteries is multi-slice computed tomography (MSCT) image data and the three-dimensional medical imaging device is a computed tomography (CT) scanner.

4. The method of claim 1, wherein the one or more fluoroscopes acquire two-dimensional image data in real-time.

5. The method of claim 1, wherein the displayed co-registered image data is used for guidance in performing percutaneous coronary intervention (PCI) for coronary arteries.

6. The method of claim 1, wherein the three-dimensional image data includes motion characteristics for the coronary arteries across a cardiac cycle.

7. The method of claim 1, wherein electrocardiography (ECG) data is acquired along with the three-dimensional image data so that the displaying of the co-registered image data in real-time is gated such that the co-registered image data is only displayed when the stage of the cardiac cycle of the real-time image data matches the stage of cardiac cycle in which the three-dimensional image data was acquired.

8. The method of claim 1, wherein the three-dimensional image data includes motion characteristics for the coronary arteries across a cardiac cycle and wherein electrocardiography (ECG) data is acquired along with the three-dimensional image data so that the co-registered image data is displayed in real-time such that the stage of the cardiac cycle of the real-time image data matches the stage of cardiac cycle of the three-dimensional image data.

9. The method of claim 1, wherein the three-dimensional image data is acquired while the patient is holding breath and breathing motion of the real-time image data is compensated for prior to co-registration.

10. The method of claim 1, wherein the one or more fluoroscopes include a first fluoroscope at a first angulation and a second fluoroscope at a second angulation, wherein the difference between the first and second angulation is between 30 and 90 degrees.

11. The method of claim 1, wherein within the display of the co-registered image data in real-time, arterial plaque image data from the three-dimensional image data is overlaid upon receiving a user-instruction.

12. A system for displaying real-time imagery of coronary arteries, comprising:
a first medical imaging device for acquiring three-dimensional image data of coronary arteries;
a second medical imaging device for acquiring real-time image data of the coronary arteries;
an image processing device for co-registering the acquired three-dimensional image data with the real-time image data and distorting the three-dimensional image data in real-time to continuously align with the real-time image data; and
a display device for displaying the real-time image data superimposed with the continuously aligned three-dimensional image data.

13. The system of claim 12, wherein the first medical imaging device is computed tomography (CT) scanner and the three-dimensional image data is multi-slice computed tomography (MSCT).

14. The system of claim 12, wherein the second medical imaging device is a fluoroscope.

15. The system of claim 14, wherein the image processing device executes a co-registration routine to perform method steps comprising:
segmenting the three-dimensional image data;
identifying a vessel structure within the segmented image data by detecting a centerline path;
determining an optimal articulation of the one or more fluoroscopes and setting each of the one or more fluoroscopes to the respective optimal articulation while real-time image data is acquired;
performing an initial co-registration of coronary arteries using the identified vessel structure within the three-dimensional image data and the real-time image data;
automatically estimating a registration matrix for distorting the three-dimensional image data to continuously align with the real-time image data based on the initial co-registration; and
rendering a superimposed visualization by combining the three-dimensional image data and the real-time image data according to the estimated registration matrix.

16. A computer system comprising:
a processor; and
a program storage device readable by the computer system, embodying a program of instructions executable by the processor to perform method steps for displaying real-time imagery of coronary arteries, the method comprising:
acquiring three-dimensional image data of coronary arteries using a three-dimensional medical imaging device;
acquiring real-time image data of the coronary arteries using one or more fluoroscopes;
co-registering the three-dimensional image data with the real-time image data using an image processing device; and
displaying the co-registered image data in real-time using a display device, wherein co-registering the three-dimensional image data with the real-time image data includes:
segmenting the three-dimensional image data;
identifying a vessel structure within the segmented image data by detecting a centerline path;
determining an optimal articulation of the one or more fluoroscopes and setting each of the one or more fluoroscopes to the respective optimal articulation while real-time image data is acquired;
performing an initial co-registration of coronary arteries using the identified vessel structure within the three-dimensional image data and the real-time image data;
automatically estimating a registration matrix for the three-dimensional image data and the real-time image data based on the initial co-registration; and
rendering a hybrid visualization by combining the three-dimensional image data and the real-time image data according to the estimated registration matrix.

17. The computer system of claim 16, wherein the displayed co-registered image data is used for guidance in performing percutaneous coronary intervention (PCI) for coronary arteries.

18. The computer system of claim 18, wherein electrocardiography (ECG) data is acquired along with the three-dimensional image data so that the displaying of the co-registered image data in real-time is gated such that the co-registered image data is only displayed when the stage of the cardiac cycle of the real-time image data matches the stage of cardiac cycle in which the three-dimensional image data was acquired.

19. The computer system of claim 18, wherein the three-dimensional image data includes motion characteristics for the coronary arteries across a cardiac cycle and wherein electrocardiography (ECG) data is acquired along with the three-dimensional image data so that the co-registered image data is displayed in real-time such that the stage of the cardiac cycle of the real-time image data matches the stage of cardiac cycle of the three-dimensional image data.

20. The computer system of claim 18, wherein the one or more fluoroscopes include a first fluoroscope at a first angulation and a second fluoroscope at a second angulation, wherein the difference between the first and second angulation is between 30 and 90 degrees.
